(19) United States
(12) Patent Application Publication
(10) Pub. No.: US 2023/0137931 A1
(43) Pub. Date: May 4, 2023

(54) METHOD FOR AUGMENTING DATA FOR DOCUMENT CLASSIFICATION AND APPARATUS THEREOF

(71) Applicant: SAMSUNG SDS CO., LTD., Seoul (KR)

(72) Inventors: Hyoseob SONG, Seoul (KR); Seongho Joe, Seoul (KR); Youngjune Gwon, Seoul (KR)

(73) Assignee: SAMSUNG SDS CO., LTD., Seoul (KR)

(21) Appl. No.: 17/972,827

(22) Filed: Oct. 25, 2022

(30) Foreign Application Priority Data
Oct. 29, 2021 (KR) 10-2021-0147372

(51) Int. Cl. G06V 30/19; G06V 30/12; G06V 30/413; G06T 7/194

(52) U.S. Cl. CPC G06V 30/19147; G06V 30/133; G06V 30/413; G06T 7/194

(57) ABSTRACT

The disclosure relates to a data augmentation method for document classification based on artificial intelligence, which includes: obtaining a plurality of document data; measuring quality information of the plurality of document data; classifying the plurality of document data by quality using the measured quality information, and detecting a distribution of the plurality of document data classified by quality; and augmenting document data corresponding to a specific quality group based on the detected document data distribution by quality.

### CROSS-REFERENCE TO RELATED APPLICATIONS

This application claims priority to Korean Patent Application No. 10-2021-0147372 filed on Oct. 29, 2021 in Korean Intellectual Property Office, the entire contents of which is hereby incorporated by reference in its entirety.

### BACKGROUND OF THE INVENTION

### 1. Field of the Invention

The present disclosure relates to a method and an apparatus for augmenting learning data and, more particularly, a method and an apparatus for augmenting learning data for artificial intelligence (AI)-based document classification.

### 2. Description of the Prior Art

Optical character recognition (OCR) refers to a technology of obtaining an image of handwritten or machine-printed text with an image scanner and converting the text into machine-readable text. Optical character recognition is a program or software that converts an image of a typed document obtained by image scanning into a computer-editable character code, and is generally referred to as OCR. OCR started in a field of research in artificial intelligence and machine vision.

Past OCR operates with a plurality of subdivided modules, such as a text line detection module and a character dividing module, and requires a human being to manually register a feature as a criterion for distinguishing characters. In addition, the past OCR limitedly operates only on high-quality images, and has a relatively low rate of recognition of handwriting or cursive writing. Unlike the past OCR that recognizes only characters in a document image, such as a business card or a document, current OCR is developing into a technology that enables recognition of characters even in a picture and a video. Currently, with the technological development of computer vision, instead of a human being manually registering a character, a computer autonomously generates rules for recognizing text from an image through massive data learning using a deep learning-based algorithm. Accordingly, the rate and accuracy of character recognition have been improved to correct a recognition error of OCR, and various algorithms for addressing shortcomings of OCR are continuously being developed.

Among these OCR technologies, document classification is a phase of classifying the type (or kind) of a target document, and is a first stage of document recognition. With the recent development of machine learning, a deep learning algorithm, which is one part of machine learning, is applied to document classification. In order to improve the accuracy of document classification using a deep learning algorithm, a general data augmentation method of adding inversion or reversal, rotation, or various types of noise produced by an image processing technique used in object recognition or character recognition is conventionally used instead of augmenting separate learning data.

Although the conventional data augmentation method is suitable to improve the accuracy of recognition in characters or words, a form in which noise produced by the image processing technique is added to the entire document is different from the form of the document actually contaminated, and thus a data augmentation method based on the structure or characteristics of an actual document is required to improve the accuracy of document classification.

### SUMMARY OF THE INVENTION

The present disclosure is to address the above-mentioned problems and other problems. Another aspect of the present disclosure is to provide a data augmentation method and an apparatus therefor capable of effectively augmenting learning data for artificial intelligence-based document classification by classifying pieces of document data by quality on the basis of quality measurement information about the pieces of document data and by using a document data distribution by quality.

In another aspect, the present disclosure is to provide a data augmentation method and an apparatus therefor capable of effectively augmenting learning data for artificial intelligence-based document classification by synthesizing a background of documents belonging to a document quality group of low weight (proportion) and a foreground of documents belonging to a document quality group of high weight (proportion).

In still another aspect, the present disclosure is to provide a data augmentation method and an apparatus therefor capable of effectively augmenting learning data for artificial intelligence-based document classification by changing the style of documents belonging to a document quality group of high weight on the basis of a background feature of documents belonging to a document quality group of low weight.

In view of the foregoing, according to an aspect of the present disclosure, a data augmentation method performed by a processor in an apparatus may include: obtaining a plurality of document data; measuring quality information of the plurality of document data; classifying the plurality of document data by quality using the measured quality information, and detecting a distribution of the plurality of document data classified by quality; and augmenting document data corresponding to a specific quality group based on the detected document data distribution by quality.

According to another aspect of the present disclosure, there is provided a data augmentation apparatus including a processor, wherein the processor performs: obtaining a plurality of document data; measuring quality information of the plurality of document data; classifying the plurality of document data by quality using the measured quality information, and detecting a distribution of the plurality of document data classified by quality; and augmenting document data corresponding to a specific quality group based on the detected document data distribution by quality.

According to another aspect of the present disclosure, there is provided a computer-readable storage medium storing instructions that cause an apparatus including a processor to perform an operation for data augmentation based on a document quality when executed by the processor, the operation including: obtaining a plurality of document data; measuring quality information of the plurality of document data; classifying the plurality of document data by quality using the measured quality information, and detecting a distribution of the plurality of document data classified by quality; and augmenting document data corresponding to a specific quality group based on the detected document data distribution by quality.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a flowchart illustrating an artificial intelligence-based document classification method according to an embodiment of the present disclosure;

FIG. 2 is a flowchart illustrating a data augmentation method according to a first embodiment of the present disclosure;

FIG. 3 illustrates criteria for quality measurement of document data;

FIG. 4 illustrates a method for selecting data to be augmented;

FIG. 5 illustrates a method for separating a foreground and a background of document data by using an artificial neural network;

FIG. 6 illustrates a data augmentation method through synthesis of a foreground and a background of document data;

FIG. 7 is a flowchart illustrating a data augmentation method according to a second embodiment of the present disclosure;

FIG. 8 illustrates a data augmentation method using a style transfer model;

FIG. 9 is a flowchart illustrating a data augmentation method according to a third embodiment of the present disclosure;

FIG. 10 illustrates a data augmentation method through foreground/background synthesis and style transfer;

FIG. 11 is a block diagram illustrating the configuration of a data augmentation apparatus according to an embodiment of the present disclosure; and

FIG. 12 illustrates an apparatus to which a proposed method of the present disclosure is applicable.

### DETAILED DESCRIPTION OF THE EXEMPLARY EMBODIMENTS

Hereinafter, embodiments disclosed herein will be described in detail with reference to the accompanying drawings. Aspects, specific advantages, and novel features of the present disclosure will be more apparent from the following detailed description and exemplary embodiments in conjunction with the accompanying drawings.

The concepts of the terms or words used in the specification and claims are appropriately defined by the inventor to describe the disclosure in an optimal manner, and these terms and words should be interpreted as having meanings and concepts in accordance with the technical idea of the present disclosure, are only for describing embodiments, and should not be construed as limiting the present disclosure.

In assigning reference numerals to components, like or similar components are assigned like reference numerals regardless of reference numerals and redundant descriptions thereof will be omitted. As used herein, the terms “module” and “unit” for components are given or interchangeably used only for ease in writing the specification, do not themselves have distinct meanings or functions, and may refer to a software or hardware component.

In describing components of the present disclosure, when a component is expressed in a singular form, it should be understood that the component also includes a plural form unless otherwise specified. Terms “first”, “second”, and the like are used to distinguish one component from another component, but the components are not limited by these terms. It should be understood that when a component is connected or coupled to another component, the component may be connected or coupled to the other element via any other element interposed therebetween.

When a detailed description about related known technology is determined to make the gist of embodiments disclosed herein unclear in describing the embodiments disclosed herein, the detailed description will be omitted herein. In addition, it should be understood that the accompanying drawings are only for easy understanding of the embodiments disclosed herein, and technical ideas disclosed herein are not limited by the accompanying drawings but include all modifications, equivalents, or substitutes included in the spirit and technical scope of the present disclosure.

The present disclosure proposes a data augmentation method and an apparatus therefor capable of effectively augmenting learning data for artificial intelligence-based document classification by classifying pieces of document data by quality on the basis of quality measurement information about the pieces of document data and by using a document data distribution by quality. The present disclosure proposes a data augmentation method and an apparatus therefor capable of effectively augmenting learning data for artificial intelligence-based document classification by synthesizing a background of documents belonging to a document quality group of low weight and a foreground of documents belonging to a document quality group of high weight. The present disclosure proposes a data augmentation method and an apparatus therefor capable of effectively augmenting learning data for artificial intelligence-based document classification by changing the style of documents belonging to a document quality group of high weight on the basis of a background feature of documents belonging to a document quality group of low weight. Hereinafter, a data augmentation method described herein may be performed by a data augmentation apparatus, and the data augmentation apparatus may be installed in an OCR system or a document classification apparatus.

Hereinafter, various embodiments of the present disclosure will be described in detail with reference to the drawings.

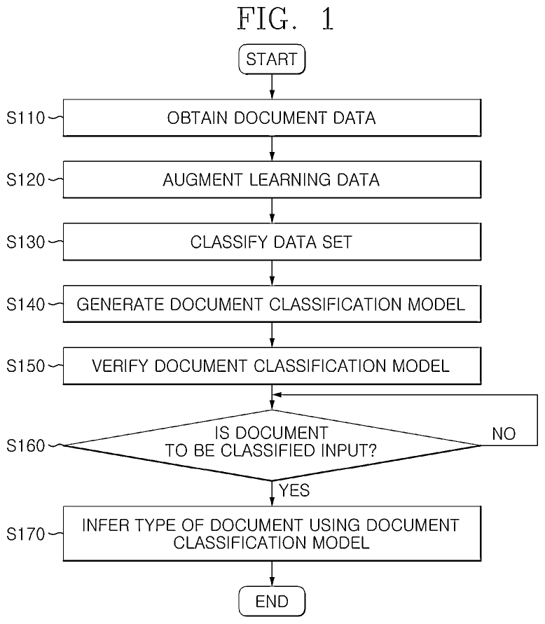

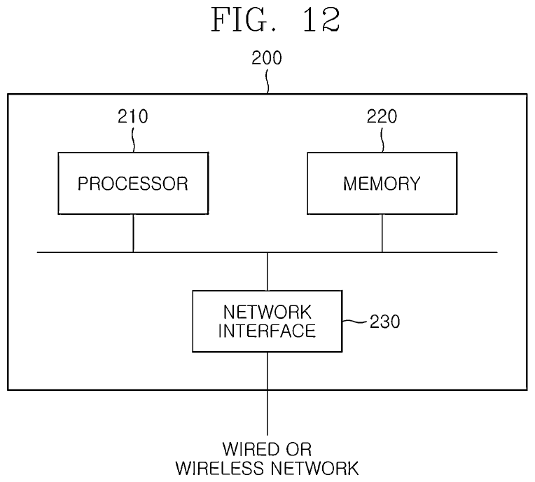

FIG. 1 is a flowchart illustrating an artificial intelligence-based document classification method according to an embodiment of the present disclosure. Operations shown in FIG. 1 may be performed by a document classification apparatus. The document classification apparatus may be configured via an apparatus shown in FIG. 12.

Referring to FIG. 1, the document classification apparatus according to the present disclosure may obtain pieces of document data to be subjected to machine learning, and may store the obtained pieces of document data in a storage (S110). Here, data to be subjected to learning includes any document data recognizable by optical character recognition (OCR).

When the quantity of the obtained pieces of document data is insufficient, the document classification apparatus may augment pieces of learning data for generating and verifying a learning model on the basis of the obtained pieces of document data (S120). The document classification apparatus may store the augmented pieces of learning data in the storage.

The document classification apparatus may perform an operation of classifying the pieces of document data stored in the storage into a learning data set and a test data set (S130). Here, the learning data set is used to generate a learning model, and the test data set is used to verify the learning model.

The document classification apparatus may generate a document classification model for inferring the type (or kind) of a document by performing a predetermined deep learning algorithm on the basis of the learning data set (S140). Here, the deep learning algorithm may be a deep neural network (DNN), a convolutional neural network (CNN), or a recurrent neural network (RNN), but is not necessarily limited thereto.

The document classification apparatus may verify the performance of the document classification model on the basis of the test data set (S150). According to an embodiment of the present disclosure, operation 130 and operation 150 described above may be omitted.

The document classification apparatus may infer (predict) the type of a document to be classified by using the document classification model generated through the foregoing machine learning process. That is, when the document to be classified is input (S160), the document classification apparatus may input the document into the pre-trained document classification model to accurately infer the type of the document (S170).

Hereinafter, a method for augmenting learning data required to generate and verify a document classification model for inferring the type of a document will be described in detail.

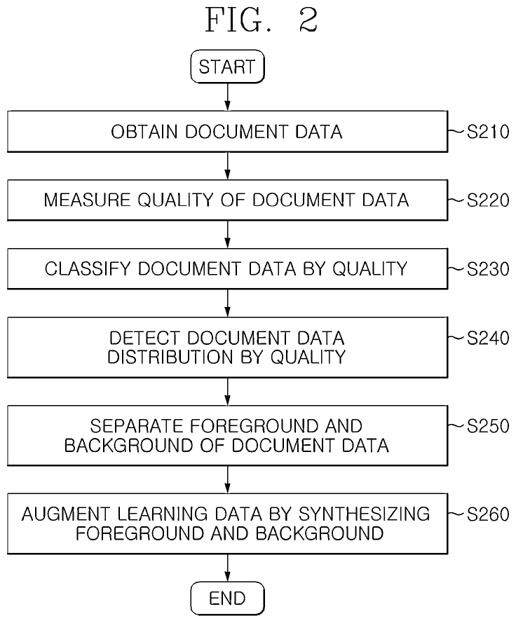

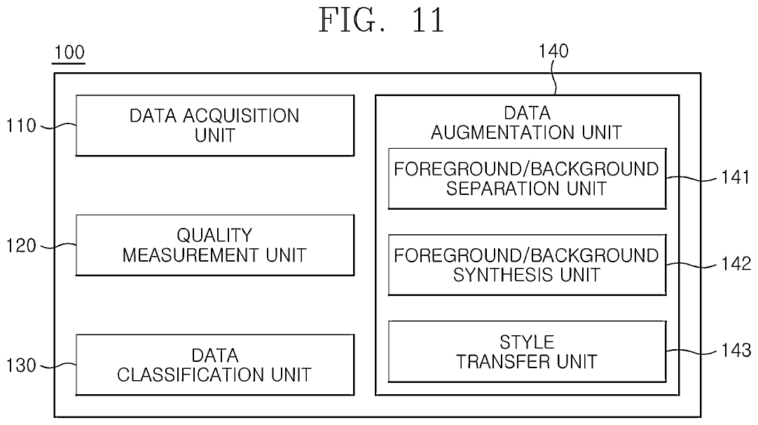

FIG. 2 is a flowchart illustrating a data augmentation method according to a first embodiment of the present disclosure. Operations shown in FIG. 2 may be performed by a data augmentation apparatus. The data augmentation apparatus may be configured via an apparatus shown in FIG. 11 and/or FIG. 12.

Referring to FIG. 2, the data augmentation apparatus according to the present disclosure may obtain pieces of document data to be subjected to machine learning, and may store the obtained pieces of document data in a storage (S210). Here, data to be subjected to learning includes any document data recognizable by optical character recognition (OCR).

The data augmentation apparatus may measure the quality of the obtained pieces of document data (S220). Here, a document area to be subjected to quality measurement may be the entire area of a document or an area in which actual content is written excluding a blank space in the document.

The data augmentation apparatus may measure the quality of the pieces of document data by using a document image attribute, such as a color distribution of a document, a noise distribution of a document, and the degree of rotation of a document. In addition, the data augmentation apparatus may measure the quality of the pieces of document data by using a character image attribute, such as the ratio of a detectable character area in a document and a normal character detection rate, along with the document image attribute.

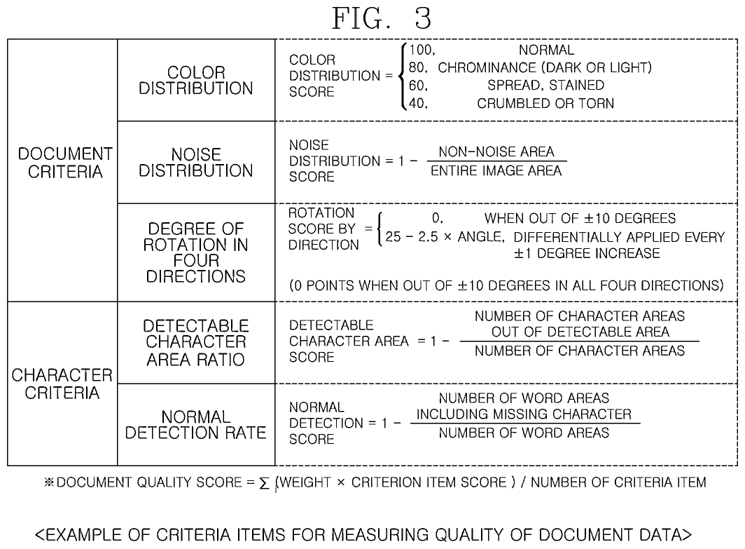

For example, as shown in FIG. 3, criteria for measuring the quality of the pieces of document data may be largely divided into a document criterion and a character criterion. Here, the document criterion may include a color distribution item, a noise distribution item, and a rotation degree item, and the character criterion may include a detectable character area ratio item and a normal character detection rate item. A score for each criterion may be calculated by equations shown in the drawing. Here, when scores for the respective criteria have different units, the units may be unified through a standardization process (e.g., into a percentage).

The data augmentation apparatus may calculate scores for a plurality of criteria, and may numerically quantify the quality of document data by applying a weighted value to each criterion. That is, the data augmentation apparatus may calculate a quality score for the document data by using Equation 1 below. Here, the total sum of weighted values for the respective criteria is set to be 1.

$$Document quality score = \frac{\sum ( Weight \times Criterion score )}{Number of criteria} \qquad [ Equation 1 ]$$

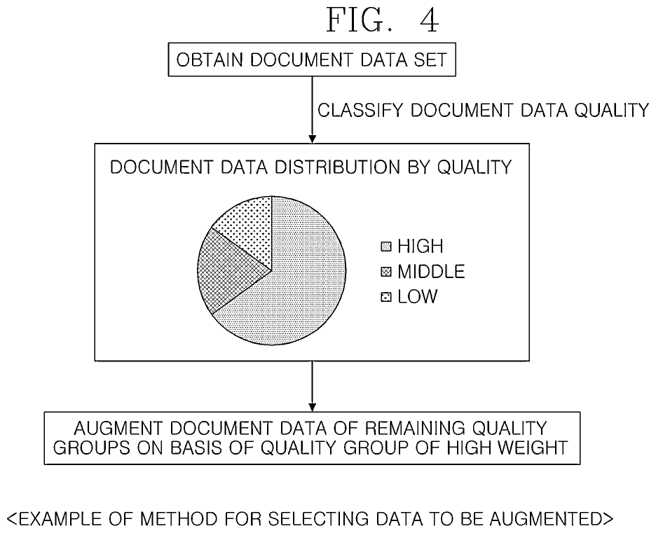

The data augmentation apparatus may classify the pieces of document data by quality on the basis of quality measurement information about the pieces of document data (S230). For example, as shown in FIG. 4, the data augmentation apparatus may classify the pieces of document data into three document quality groups (i.e., a high quality group, a medium quality group, and a low quality group) according to quality scores for the pieces of document data.

The data augmentation apparatus may detect distribution of pieces of document data grouped by quality (S240). For example, as shown in FIG. 4, the data augmentation apparatus may measure the quantity of pieces of document data belonging to the three document quality groups to detect the distribution of pieces of document data by each quality.

The data augmentation apparatus may augment document data corresponding to a document quality group of low weight on the basis of document data distribution information by quality to be similar to distribution of document data corresponding to a document quality group of high weight. For example, as shown in FIG. 4, the data augmentation apparatus may augment pieces of document data corresponding to the medium/low quality group on the basis of the quantity of pieces of document data belonging to the high quality group.

The data augmentation apparatus may separate a foreground and a background of the pieces of document data (S250). Here, the foreground refers to an important object in a field of vision, and the background refers to a less important object as the rest. The foreground is regarded as having a definite form, while the background is regarded as lacking a form. Further, the foreground appears to be in front of the background, and the background appears to be behind the foreground.

Document data subject to foreground and background separation may be all pieces of document data. Alternatively, document data subject to foreground separation and document data subject to background separation may be pieces of document data belonging to different quality groups. For example, the document data subject to the foreground separation may be document data belonging to a first quality group, and the document data subject to the background separation may be document data belonging to a second quality group.

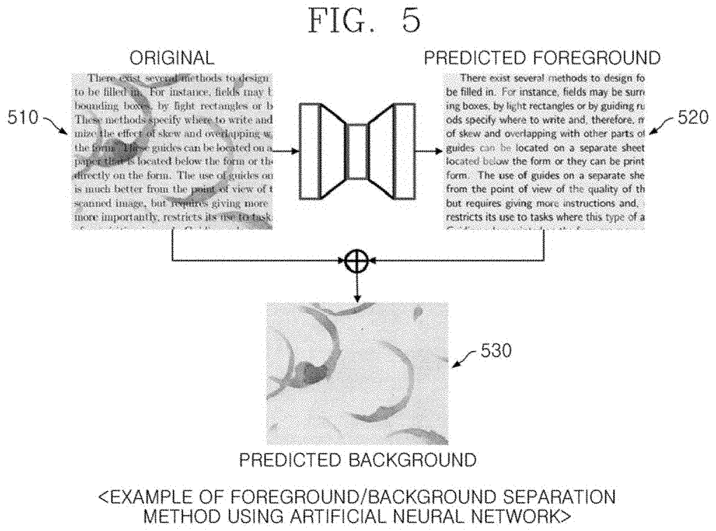

A method for separating a foreground and a background of document data may employ various separation methods, such as a method using a template, a method considering influence between pixels, and a method using an artificial neural network (ANN), but is not necessarily limited thereto. Hereinafter, in this embodiment, a process of separating a foreground and a background of a document through a method using an artificial neural network will be described for illustration. For example, as shown in FIG. 5, the data augmentation apparatus may predict a foreground image 520 of a document on the basis of an original image 510 of the document by using a variable auto encoder. The data augmentation apparatus may extract a background image 530 of the document on the basis of the original image 510 of the document and the predicted foreground image 520.

The data augmentation apparatus may augment learning data by synthesizing foregrounds of pieces of document data belonging to the document quality group of high weight and backgrounds of pieces of document data belonging to the document quality group of low weight (S260). Here, a method for synthesizing a foreground and a background may employ various synthesis methods, such as a simple synthesis method using a matrix operation, a synthesis method using blending by image processing, and a synthesis method using an image feature, but is not necessarily limited thereto.

The data augmentation apparatus may randomly mix a plurality of foregrounds extracted from the pieces of document data of the document quality group of high weight and a plurality of backgrounds extracted from the pieces of document data of the document quality group of low weight, and may merge as many foregrounds and backgrounds as the data augmentation apparatus is required to augment, thereby generating new types of pieces of document data.

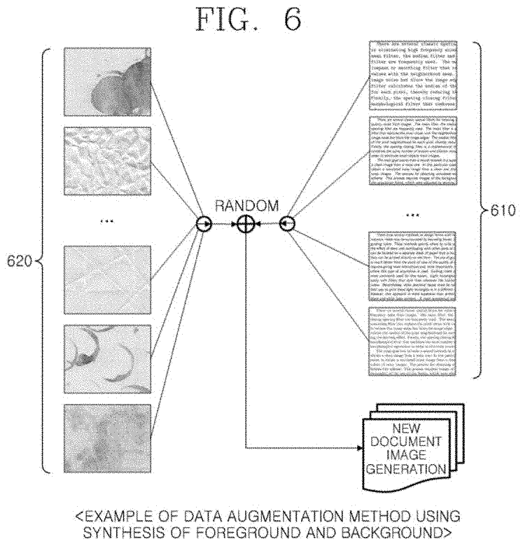

For example, as shown in FIG. 6, when high-quality document data has the highest weight as a result of analyzing the distribution of pieces of document data by each quality, the data augmentation apparatus may randomly synthesize foregrounds 610 extracted from the pieces of document data of the high quality group and backgrounds 620 extracted from the pieces of document data of the medium/low quality group, thereby augmenting medium/low-quality document data having a relatively low weight.

Although this embodiment shows that the entire area of a background image and the entire area of a foreground image are merged, the present disclosure is not necessarily limited thereto, and it will be obvious to those skilled in the art that a partial area of a background image and the entire area of a foreground image may be merged.

As described above, the data augmentation method according to the first embodiment of the present disclosure may randomly synthesize a background image of documents belonging to the document quality group of low weight and a foreground image of documents belonging to the document quality group of high weight, thereby effectively augmenting learning data for document classification based on artificial intelligence.

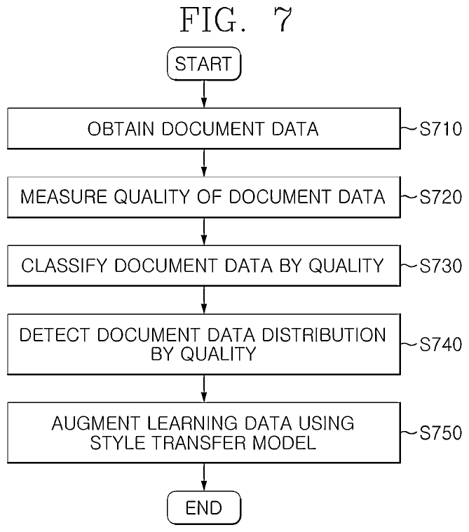

FIG. 7 is a flowchart illustrating a data augmentation method according to a second embodiment of the present disclosure. Operations shown in FIG. 7 may be performed by a data augmentation apparatus. The data augmentation apparatus may be configured via the apparatus shown in FIG. 11 and/or FIG. 12.

Referring to FIG. 7, operation 710 to operation 740 of the data augmentation method according to the present embodiment are the same as or similar to operation 210 to operation 240 of FIG. 2, and thus a detailed description thereof will be omitted.

The data augmentation apparatus according to the present disclosure may obtain pieces of document data to be subjected to machine learning, and may store the obtained pieces of document data in a storage (S710).

The data augmentation apparatus may measure the quality of the obtained pieces of document data (S720). The data augmentation apparatus may classify the pieces of document data by quality on the basis of quality measurement information about the pieces of document data (S730). The data augmentation apparatus may detect distribution of the pieces of document data classified by quality (S740).

The data augmentation apparatus may augment document data corresponding to a document quality group of low weight on the basis of document data distribution information by quality to be similar to distribution of document data corresponding to a document quality group of high weight. To this end, in this embodiment, the document data may be augmented by using a style transfer method. The style transfer method is an optimization technique that uses a content image and a style reference image to generate a new image that retains the content image but appears to be painted in the style of the style reference image.

The data augmentation apparatus may augment learning data by using a style transfer model (S750). Here, the style transfer model may be configured through an artificial neural network (ANN), such as a convolutional neural network (CNN) or a generative adversarial network (GAN), but is not necessarily limited thereto.

The style transfer model according to the present disclosure may extract a background feature of pieces of document data belonging to the document quality group of low weight, and may change the style of pieces of document data belonging to the document quality group of high weight on the basis of the extracted background feature.

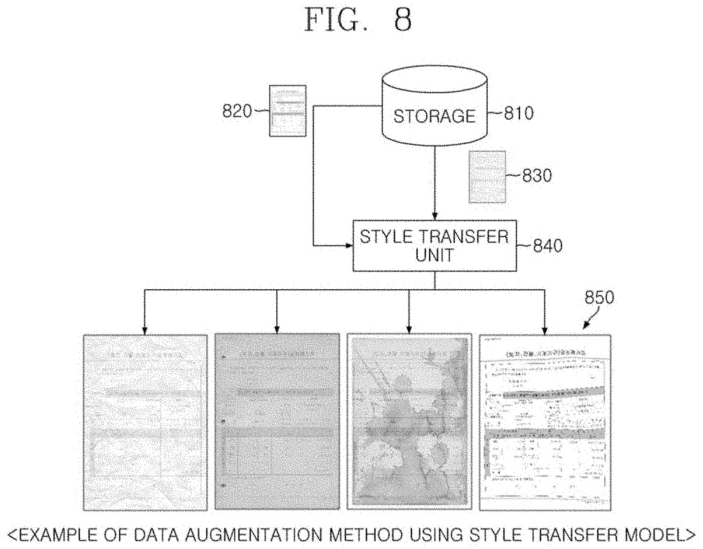

For example, as shown in FIG. 8, when high-quality document data has the highest weight as a result of analyzing the distribution of pieces of document data by each quality, pieces of document data 820 of a high quality group and pieces of document data 830 of a medium/low quality group stored in a storage 810 may be input to a style transfer unit 840. The style transfer unit 840 may extract a background feature of the pieces of document data 830 belonging to the medium/low quality group by using the style transfer model, and may change the style of the document data 820 belonging to the high quality group on the basis of the extracted background feature, thereby generating a plurality of pieces of document data 850.

As described above, the data augmentation method according to the second embodiment of the present disclosure may change the style of documents belonging to the document quality group of high weight on the basis of a background feature of documents belonging to the document quality group of low weight, thereby effectively augmenting learning data for document classification based on artificial intelligence.

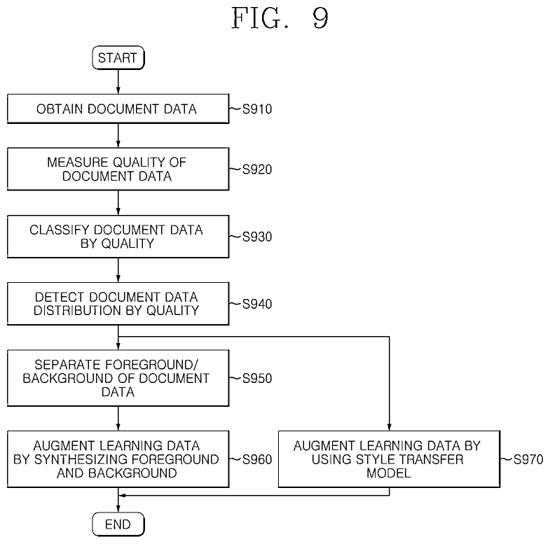

FIG. 9 is a flowchart illustrating a data augmentation method according to a third embodiment of the present disclosure. Operations shown in FIG. 9 may be performed by a data augmentation apparatus. The data augmentation apparatus may be configured via the apparatus shown in FIG. 11 and/or FIG. 12.

Referring to FIG. 9, operation 910 to operation 940 of the data augmentation method according to the present embodiment are the same as or similar to operation 210 to operation 240 of FIG. 2, and thus a detailed description thereof will be omitted.

The data augmentation apparatus according to the present disclosure may obtain pieces of document data to be subjected to machine learning, and may store the obtained pieces of document data in a storage (S910).

The data augmentation apparatus may measure the quality of the obtained pieces of document data (S920). The data augmentation apparatus may classify the pieces of document data by quality on the basis of quality measurement information about the pieces of document data (S930). The data augmentation apparatus may detect distribution of the pieces of document data classified by quality (S940).

The data augmentation apparatus may augment document data corresponding to a document quality group of low weight on the basis of document data distribution information by quality to be similar to distribution of document data corresponding to a document quality group of high weight. To this end, in this embodiment, the document data may be augmented by using both a foreground/background synthesis method and a style transfer method.

The data augmentation apparatus may separate a foreground and a background of the pieces of document data by using a predetermined separation method (S950).

The data augmentation apparatus may augment learning data by randomly synthesizing foregrounds of pieces of document data belonging to the document quality group of high weight and backgrounds of pieces of document data belonging to the document quality group of low weight (S960).

The data augmentation apparatus may augment the learning data by using a pre-trained style transfer model independently of the foregoing data augmentation method (S970). Here, the style transfer model may extract a background feature of the pieces of document data belonging to the document quality group of low weight, and may change the style of the pieces of document data belonging to the document quality group of high weight on the basis of the extracted background feature.

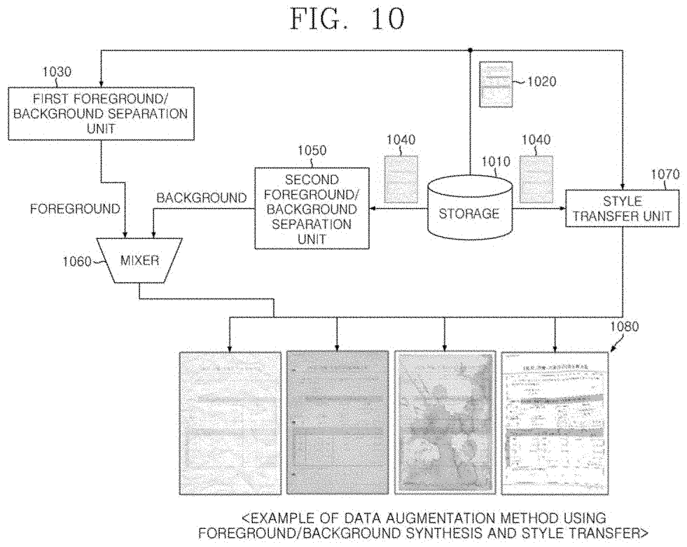

For example, as shown in FIG. 10, when high-quality document data has the highest weight as a result of analyzing the distribution of document data for each quality, pieces of document data 1020 of a high quality group stored in a storage 1010 are input to a first foreground/background separation unit 1030, and pieces of document data 1040 of a medium/low quality group stored in the storage 1010 are input to a second foreground/background separation unit 1050. The first foreground/background separation unit 1030 separates a foreground of the pieces of document data 1020 belonging to the high quality group and provides the foreground to a mixer (or a foreground/background synthesis unit) 1060, and the second foreground/background separation unit 1050 separates a background of the pieces of document data 1040 belonging to the medium/low quality group and provides the background to the mixer 1060. The mixer 1060 may generate a plurality of pieces of document data 1080 by synthesizing the foreground of the pieces of document data 1020 belonging to the high quality group and the background of the pieces of document data 1040 belonging to the medium/low quality group.

The pieces of document data 1020 of the high quality group and the pieces of document data 1040 of the medium/low quality group stored in the storage 1010 may be input to a style transfer unit 1070. The style transfer unit 1070 may extract a background feature of the pieces of document data 1040 belonging to the medium/low quality group by using the style transfer model, and may change the style of the document data 1020 belonging to the high quality group on the basis of the extracted background feature, thereby generating a plurality of pieces of document data 1080.

As described above, the data augmentation method according to the third embodiment of the present disclosure may use both a method of synthesizing a background image of documents belonging to the document quality group of low weight and a foreground image of documents belonging to the document quality group of high weight and a method of changing the style of the documents belonging to the document quality group of high weight on the basis of a background feature of the documents belonging to the document quality group of low weight, thereby effectively augmenting learning data for document classification based on artificial intelligence.

FIG. 11 is a block diagram illustrating the configuration of a data augmentation apparatus according to an embodiment of the present disclosure.

Referring to FIG. 11, the data augmentation apparatus 100 according to the embodiment of the present disclosure may include a data acquisition unit 110, a quality measurement unit 120, a data classification unit 130, and a data augmentation unit 140. The components shown in FIG. 11 are not essential for configuring the data augmentation apparatus, and thus the data enhancement apparatus described herein may include more or fewer components than those listed above.

The data acquisition unit 110 may obtain pieces of document data to be subjected to machine learning. The data acquisition unit 110 may store the obtained pieces of document data in a storage. Here, data to be subjected to learning includes any document data recognizable by optical character recognition (OCR).

The quality measurement unit 120 may measure the quality of the pieces of document data stored in a storage. Here, a document area to be subjected to quality measurement may be the entire area of a document or an area in which actual content is written excluding a blank space in the document.

The quality measurement unit 120 may measure the quality of the pieces of document data by using a document image attribute, such as a color distribution of a document, a noise distribution of the document, and the degree of rotation of the document and/or a character image attribute, such as the ratio of a detectable character area in a document and a normal character detection rate, along with the document image attribute.

The data classification unit 130 may classify the pieces of document data by quality on the basis of quality measurement information about the pieces of document data. That is, the data classification unit 130 may classify the pieces of document data into a predetermined number of quality groups according to quality scores for the pieces of document data.

The data classification unit 130 may detect distribution of pieces of document data grouped by quality. Here, the data classification unit 130 may measure the quantity of pieces of document data belonging to a predetermined number of quality groups to detect the distribution of pieces of document data by each quality group.

The data augmentation unit 140 may augment document data corresponding to a document quality group of low weight on the basis of document data distribution information by quality. That is, the data augmentation unit 140 may augment the document data corresponding to the document quality group of low weight on the basis of the quantity of pieces of document data belonging to a document quality group of high weight.

The data augmentation unit 140 may augment document data for document classification based on artificial intelligence by using at least one of a method of synthesizing a foreground and a background of a document and a method using a style transfer model. To this end, the data augmentation unit 140 may include a foreground/background separation unit 141, a foreground/background synthesis unit 142, and a style transfer unit 143.

The foreground/background separator 141 may separate a foreground and a background of the pieces of document data by using a predetermined separation method. Here, the separation method may employ a method using a template, a method considering influence between pixels, a method using an artificial neural network (ANN), and the like, but is not necessarily limited thereto.

The foreground/background synthesis unit (or mixer) 142 may augment learning data by synthesizing foregrounds extracted from pieces of document data of the document quality group of high weight and backgrounds extracted from pieces of document data of the document quality group of low weight. Here, a method for synthesizing a foreground and a background may employ a simple synthesis method using a matrix operation, a synthesis method using blending by image processing, a synthesis method using an image feature, and the like, but is not necessarily limited thereto.

The style transfer unit 143 may augment learning data by using a pre-trained style transfer model. Here, the style transfer model may extract a background feature of the pieces of document data belonging to the document quality group of low weight, and may change the style of the pieces of document data belonging to the document quality group of high weight on the basis of the extracted background feature.

As described above, the data augmentation apparatus according to an embodiment of the present disclosure may measure the quality of pieces of document data, and may group the pieces of document data by quality on the basis of information about the measured quality of the data, thereby augmenting document data corresponding to the document quality group of low weight on the basis of the quantity of the pieces of document data belonging to the document quality group of high weight.

FIG. 12 illustrates an apparatus 200 to which the proposed methods of the present disclosure are applicable.

Referring to FIG. 12, the apparatus 200 may be configured to implement a document classification process and/or a data augmentation process according to the proposed methods of the present disclosure. Further, the apparatus 200 may be the foregoing document classification apparatus or one or more components included in the components forming the document classification apparatus. In addition, the apparatus 200 may be the foregoing data augmentation apparatus 100 or one or more components included in the components forming the data augmentation apparatus 100.

For example, the apparatus 200 to which the proposed methods of the present disclosure are applicable may include a network device such as a repeater, a hub, a bridge, a switch, a router, and a gateway, a computer device such as a desktop computer and a workstation, a mobile terminal such as a smartphone, a portable device such as a laptop computer, a home appliance such as a digital TV, and a transportation system such as a car. In another example, the device 200 to which the present disclosure is applicable may be included as a part of an application-specific integrated circuit (ASIC) configured in the form of a system-on-chip (SoC).

A memory 220 may be operatively connected to a processor 210, may store a program and/or instructions for processing and control of the processor 210, and may store data and information used in the present disclosure, control information necessary to process data and information according to the present disclosure, and temporary data generated in a process of processing data and information. The memory 220 may be configured as a storage device, such as a read-only memory (ROM), a random access memory (RAM), an erasable programmable read-only memory (EPROM), an electrically erasable programmable read-only memory (EEPROM), a flash memory, a static RAM (SRAM), a hard disk drive (HDD), and a solid state drive (SSD).

The processor 210 may be operatively connected to the memory 220 and/or a network interface 230, and controls the operation of each module in the device 200. In particular, the processor 210 may perform various control functions for performing the proposed methods of the present disclosure. The processor 210 may also be referred to as a controller, a microcontroller, a microprocessor, a microcomputer, or the like. The proposed methods of the present disclosure may be implemented by hardware, firmware, software, or a combination thereof. When the present disclosure is implemented by using hardware, an application-specific integrated circuit (ASIC) a digital signal processor (DSP), a digital signal processing device (DSPD), a programmable logic device (PLD), a field programmable gate array (FPGA), and the like may be provided in the processor 210. When the proposed methods of the present disclosure are implemented by using firmware or software, the firmware or software may include instructions related to a module, a procedure, or a function that performs functions or operations necessary to implement the proposed methods of the present disclosure, and the instructions may be stored in the memory 220 or in a computer-readable recording medium (not shown) separately from the memory 220, and may be configured to cause the device 200 to implement the proposed methods of the present disclosure when executed by the processor 210.

The apparatus 200 may include the network interface device 230. The network interface device 230 may be operatively connected to the processor 210, and the processor 210 may control the network interface device 230 to transmit or receive a wireless/wired signal carrying information and/or data, a signal, a message, and the like through a wireless/wired network. The network interface device 230 supports various communication standards, for example, IEEE 802 standards, 3GPP LTE(-A), and 3GPP 5G, and may transmit and receive control information and/or a data signal according to the corresponding communication standards. The network interface device 230 may be configured outside the apparatus 200 as needed.

A data augmentation method and an apparatus therefor according to the embodiments of the present disclosure may have the following effects.

According to at least one of the embodiments of the present disclosure, it is possible to measure the quality of pieces of document data and to group the pieces of document data by quality on the basis of information about the measured quality of the data, thereby augmenting document data corresponding to a document quality group of low weight on the basis of the quantity of pieces of document data belonging to a document quality group of high weight.

Further, according to at least one of the embodiments of the present disclosure, it is possible to randomly synthesize a background image of documents belonging to the document quality group of low weight and a foreground image of documents belonging to the document quality group of high weight, thereby effectively augmenting learning data for document classification based on artificial intelligence.

In addition, according to at least one of the embodiments of the present disclosure, it is possible to change the style of the documents belonging to the document quality group of high weight on the basis of a background feature of the documents belonging to the document quality group of low weight, thereby effectively augmenting learning data for document classification based on artificial intelligence.

The effects obtainable by the data augmentation method and the apparatus therefor according to the embodiments of the present disclosure are not limited to the effects mentioned above, and other effects not mentioned will be clearly understood by those skilled in the art from the following description.

The present disclosure described above may be realized as a computer-readable code in a medium recording a program. A computer-readable medium may continue to store a computer-executable program, or may temporarily store the computer-executable program for execution or download. Further, the medium may include various recording devices or storage devices in a form in which a single piece or a plurality of pieces of hardware is combined, and may be distributed on a network without being limited to a medium directly connected to a computer system. Therefore, the above detailed description should not be construed as restrictive in all aspects and should be considered as illustrative. The scope of the present disclosure should be determined on the basis of reasonable interpretation of the appended claims, and all changes and modifications within the equivalent scope of the present disclosure are included in the scope of the disclosure.

The present disclosure is not limited to the embodiments described above and the appended drawings, but may be configured in different specific forms. It will be obvious to those skilled in the art to which the present disclosure pertains that a component according to the present disclosure described above can be substituted, modified, or changed within the spirit and scope of the present disclosure.

What is claimed is:

1. A data augmentation method performed by a processor in an apparatus, the method comprising:
obtaining a plurality of document data;
measuring quality information of the plurality of document data;
classifying the plurality of document data by quality using the measured quality information, and detecting a distribution of the plurality of document data classified by quality; and
augmenting document data corresponding to a specific quality group based on the detected document data distribution by quality.

2. The data augmentation method of claim 1, wherein the measuring the quality information comprises measuring the quality information of the plurality of document data based on a document image attribute comprising at least one of a color distribution of a document, a noise distribution of a document, and a degree of rotation of a document.

3. The data augmentation method of claim 2, wherein the measuring the quality information comprises measuring the quality information of the plurality of document data based on a character image attribute comprising at least one of a ratio of a detectable character area in a document and a normal character detection rate, along with the document image attribute.

4. The data augmentation method of claim 1, wherein the augmenting the document data comprises augmenting document data corresponding to a document quality group of low weight on the basis of a quantity of a plurality of document data belonging to a document quality group of high weight.

5. The data augmentation method of claim 1, further comprising separating a foreground and a background of the plurality of document data using a predetermined separation method.

6. The data augmentation method of claim 5, wherein the predetermined separation method comprises at least one of a method using a template, a method considering influence between pixels, and a method using an artificial neural network (ANN).

7. The data augmentation method of claim 5, wherein the augmenting the document data comprises generating a plurality of new document data by synthesizing a foreground extracted from a plurality of document data in a document quality group of high weight and a background extracted from a plurality of document data in a document quality group of low weight.

8. The data augmentation method of claim 7, wherein a method for synthesizing the foreground and the background comprises at least one of a synthesis method using a matrix operation, a synthesis method using blending of image processing, a synthesis method using an image feature.

9. The data augmentation method of claim 1, wherein the augmenting the document data comprises augmenting the document data corresponding to the specific quality group using a style transfer model.

10. The data augmentation method of claim 9, wherein the style transfer model detects a background feature of a plurality of document data belonging to a document quality group of low weight, and changes a style of a plurality of document data belonging to a document quality group of high weight based on the detected background feature.

11. A computer-readable storage medium storing instructions that cause an apparatus comprising a processor to perform operations for data augmentation based on a document quality when executed by the processor, the operations comprising:
obtaining a plurality of document data;
measuring quality information of the plurality of document data;
classifying the plurality of document data by quality using the measured quality information, and detecting a distribution of the plurality of document data classified by quality; and
augmenting document data corresponding to a specific quality group based on the detected document data distribution by quality.

12. A data augmentation apparatus comprising a processor,
wherein the processor is configured to perform operations for data augmentation, the operations comprising:
obtaining a plurality of document data;
measuring quality information of the plurality of document data;
classifying the plurality of document data by quality using the measured quality information, and detecting a distribution of the plurality of document data classified by quality; and
augmenting document data corresponding to a specific quality group based on the detected document data distribution by quality.

13. The data augmentation apparatus of claim 12, wherein an operation for measuring the quality information comprises an operation for measuring the quality information of the plurality of document data based on a document image attribute comprising at least one of a color distribution of a document, a noise distribution of a document, and a degree of rotation of a document.

14. The data augmentation apparatus of claim 12, wherein an operation for augmenting the document data comprises an operation for augmenting document data corresponding to a document quality group of low weight on the basis of a quantity of a plurality of document data belonging to a document quality group of high weight.

15. The data augmentation apparatus of claim 12, wherein an operation for augmenting the document data comprises operations for:
separating a foreground and a background of the plurality of document data; and
synthesizing a foreground extracted from a plurality of document data in a document quality group of high weight and a background extracted from a plurality of document data in a document quality group of low weight.

16. The data augmentation apparatus of claim 15, wherein an operation for separating the foreground and the background comprises an operation for separating the foreground and the background of the plurality of document data by using at least one of a method using a template, a method considering influence between pixels, and a method using an artificial neural network (ANN).

17. The data augmentation apparatus of claim 15, wherein an operation for synthesizing the foreground and the background comprises an operation for synthesizing the extracted foreground and the extracted background by using at least one of a synthesis method using a matrix operation, a synthesis method using blending by image processing, a synthesis method using an image feature.

18. The data augmentation apparatus of claim 12, wherein an operation for augmenting the document data comprises an operation for augmenting the document data corresponding to the specific quality group using a style transfer model.

19. The data augmentation apparatus of claim 18, wherein the style transfer model extracts a background feature of a plurality of document data belonging to a document quality group of low weight, and changes a style of a plurality of document data belonging to a document quality group of high weight based on the extracted background feature.

20. The data augmentation apparatus of claim 12, wherein an operation for augmenting the document data comprises operations for:
separating a foreground and a background of the plurality of document data;
synthesizing a foreground extracted from a plurality of document data in a document quality group of high weight and a background extracted from a plurality of document data in a document quality group of low weight; and
augmenting the document data corresponding to the specific quality group using a style transfer model.
